(19) United States
(12) Patent Application Publication
(10) Pub. No.: US 2004/0157960 A1
(43) Pub. Date: Aug. 12, 2004

(54) Retroreflective aerosol coating composition and methods of making and using thereof

(75) Inventor: Peter G. Rowe, Fergus (CA)

Correspondence Address: Toby H. Kusmer, McDERMOTT, WILL & EMERY, 28 State Street, Boston, MA, 02109-1775, US

(73) Assignee: LIGHT BEAD LLC

(21) Appl. No.: 10/641,155

(22) Filed: Aug. 15, 2003

Related U.S. Application Data
(60) Provisional application No. 60/403,626, filed on Aug. 15, 2002.

(51) Int. Cl. C09D 101/10; F21V 7/22; C09K 3/00

(52) U.S. Cl. 523/172; 106/287.1; 106/162.7

(57) ABSTRACT

The present invention is directed to package stable retroreflective compositions and processes of making and using the retroreflective compositions. In particular, the retroreflective compositions of the present invention are utilized in aerosol applicators from which the retroreflective compositions can be sprayed onto a desired substrate's surface.

### RELATED APPLICATIONS

This application claims priority to U.S. provisional patent application Ser. No. 60/403,626, filed Aug. 15, 2002, which is incorporated herein by reference in its entirety.

### FIELD OF THE INVENTION

The invention relates generally to retroreflective compositions and processes of making and using the retroreflective compositions. In particular, the retroreflective compositions of the present invention are utilized in aerosol applicators from which the retroreflective compositions can be sprayed onto a desired substrate's surface.

### BACKGROUND OF THE INVENTION

Retroreflective paints, inks and coatings are used in a variety of applications. Retroreflective paints and coatings are widely used to improve the visibility of road signs, road markers and road stripes during nighttime driving. Further, the retroreflective paints are used for automobiles, boats, airplanes and appliances. The textile industry uses retroreflective coatings and inks to produce reflective fabrics.

Retroreflectivity is often provided by a layer of tiny glass or clear plastic microspheres that cooperate with a reflective agent, such as a layer of a reflective metal, including aluminum and silver. Retroreflection occurs by the tandem action of refraction of the light through the upper incident surface of the microsphere, internal reflection from the lower inside surface of the microsphere, and subsequent refraction of the light as it exits upper surface of the microsphere, traveling back in the direction from which the impinging light came. A significant portion of the light is retroreflected, with possibly only nominal losses for some reflection at the upper surface and lower surface.

U.S. Pat. No. 5,650,213 describes a process for applying a retroreflective agent to microspheres or beads. A bead-coated carrier web is then passed through a region of a high vacuum deposition chamber wherein a retroreflective layer is deposited over the exposed hemispheres of the microsphere beads. High vacuum deposition procedures and application methods concerning this process are well known. An aluminum deposit of approximately 50 to 250 Angstroms is sufficient to provide an opaque deposit with retroreflective properties.

An aerosol means of application of glass microspheres has been suggested in the art. In U.S. Pat. No. 2,963,378, there is suggested the use of glass microspheres for certain formulations which include aerosols. The beads are provided with a metallic coating over approximately one-half of their surface. The low solids paint composition contains a major amount by weight of volatile organic solvents, 35 to 65 weight percent of retroreflective glass beads of 10 to 500 micron diameter and solvent-drying, film-forming binder materials to provide reflex-reflecting, non-diffusing coatings. The retroreflective glass beads may be mixtures of glasses having different refractive indexes, and their surfaces may be coated with transparent pigment or dye to retro-reflect in color. The coatings have glass bead protrusions and are covered with a top coating of transparent varnish, which may be colored, to provide a flat glossy surface.

U.S. Pat. No. 3,228,897 relates to certain coating compositions containing glass beads which are stated to be capable of application by various techniques, including spray methods. The patent contains one example of a composition indicated to be of use in an aerosol container, although no actual example of an aerosol formulation is present. The beads are indicated to have a particle size of about 25 to about 75 microns, but only glass beads having particle sizes in the 20-45 micron size range are actually used in the working examples. Further, the beads are applied in combination with a reflective metallic pigment which acts to form reflective back surfaces for the glass beads.

U.S. Pat. No. 5,169,558 discloses a two-part aerosol system for purportedly increasing the reflex-reflectivity of a substrate. The system comprises a first aerosol dispensing means containing a first coating composition capable of forming a base-coating on a substrate and a second aerosol dispensing means containing a second coating composition capable of imparting reflex-reflectivity to said base-coating. The first coating composition comprises a binder resin and a solvent in which the binder resin is dissolved, and also may contain one or more coloring agents such as pigments and dyes. The second coating composition contains transparent microspheres having a particle size from about 45 to about 90 microns and a carrier in which the transparent microspheres are dispersible. The carrier is also capable of softening or partially dissolving the binder resin in the base-coating. The binder resin, when in a softened or partially dissolved state, adheres the transparent microspheres to the substrate.

For the application of retroreflective paints, inks and coatings to surfaces, a low viscosity is often useful. However, if a paint, ink or coating is formulated with a pigment volume that exceeds its capacity to coat each pigment particle, the resulting product can be deficient in physical properties and chemical resistance. Rapid settling prevents proper application by spraying or other methods. Moreover, commercially available package stable retroreflective inks and coatings often require the addition of a catalyst for use. However, several hours after the addition of the catalyst, the product undesirably gels. The remaining unusable product must be discarded thereby driving up costs.

Thus, there is a need in the aerosol art to provide retroreflective paints, inks and coatings which exhibit improved package stability as well as outdoor durability and washability following its curing to a substrate's surface.

### SUMMARY OF THE INVENTION

The invention provides for package-stable retroreflective water- or solvent-thinned paint, ink and coating compositions and methods of making the same. The compositions of the present invention comprise light-transmissive plastics or glass microspheres. The microspheres are optically clear and have an index of refraction of about 1.8 or higher, preferably of about 1.9 to about 2.8, and mixtures thereof. The microspheres are between 1 to 100 microns in diameter, preferably between 10 to 80 micrometers and mixtures thereof. Practical levels of reflectivity are obtained by a percentage of the glass or plastic microspheres that are hemispherically metallized with a reflective metal, preferably aluminum, silver and gold. The compositions are package stable with a package life in excess of two years. Moreover, once cured onto a desired surface, the retroreflective compositions of the present invention exhibit outdoor durability and washability in excess of two years.

An advantage of the present invention is a retroreflective composition comprising a plurality of retroreflective microspheres; a binder system; and a thixotropic blend comprising at least two thixotropic agents. The thixotropic blend is present in an amount from about three to about five percent by weight of the retroreflective composition.

Another advantage of the present invention is a method of making a retroreflective composition comprising the sequential steps of (a) dispersing a polymeric binder in a portion of a first solvent to form a liquid mass; (b) dispersing and activating at least two thixotropes in said liquid mass; (c) adding the balance of the first solvent; and (d) adding a plurality of retroreflective microspheres, wherein the retroreflective composition comprises from about three to about five percent by weight of the at least two thixotropes.

Additional aspects and features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims. Moreover, additional advantages and aspects of the present invention will become readily apparent to those skilled in the art from the following detailed description, wherein embodiments of the present invention are described, simply by way of illustration of the best mode contemplated for practicing the present invention. As will be described, the present invention is capable of other and different embodiments, and its several details are susceptible of modification in various obvious respects, all without departing from the spirit of the present invention. Unless defined otherwise, all technical and scientific terms used herein have the same meaning as commonly understood by one of ordinary skill in the art to which this invention belongs. Accordingly, the description is to be regarded as illustrative in nature, and not as limitative.

### DETAILED DESCRIPTION OF THE INVENTION

The retroreflective compositions of the present invention comprise retroreflective microspheres formed from clear plastics or glass (i.e. silica glass, quartz, soda lime glass, etc.). The microspheres may be cast from molten glass compositions applied to corresponding cavities on a drum or plate, spraying of the molten composition through a nozzle for air cooling, or by any of the conventional processes currently used to produce commercially-available clear or tinted microspheres. The light-refractive microspheres must be light-transmissive and have an index of refraction of about 1.8 or higher, preferably from about 1.9 to about 2.8, and mixtures thereof. Practical retroreflective compositions of the present invention contain a sufficient volume of microspheres, based on total dry solids volume, to allow the formation of an air interface at the glass or plastic surface.

In another embodiment, the microspheres are placed in a fluidized bed and a measured amount of transparent colored powder coating is then added. The air temperature is raised to the melting point of the powder coating, which powder coating then fuses onto the microspheres. The coating can be cured using additional heat, ultra-violet or other radiation curing technique. The resulting product can be used as is, or hemispherically metallized.

The retroreflective microspheres may be optically opaque, preferably vacuum-metallized to form hemispherically metallized microspheres, which reflect or emit and disperse light from their surfaces into and through the refractive microspheres, or against color enhancing pigments, dyes, flakes, etc., in the form of scattered or dispersed colored light which gives added depth and intensity to the visual appearance and color of the paint layer. High vacuum deposition procedures to form hemispherically metallized microspheres are well known. An aluminum deposit of approximately 50 to 500 Angstroms, preferably 200 to about 400 Angstroms, is sufficient to provide an opaque deposit with retroreflective properties. Silver and gold may also be used to hemispherically metallize the microspheres. Further, in certain embodiments, a double metallizing method is used wherein an initial layer of silver or gold is deposited, followed by an overlay deposit of aluminum. To obtain practical levels of retroreflectivity, a percentage of microspheres are hemispherically metallized. A practical range of metallized to non-metallized microspheres mixtures is from 100% (highest retroreflectivity) to 3% of total microspheres. However, in certain embodiments, all of the microspheres can be “bare” (i.e. non-metallized) microspheres, since reflectivity exists even without the metallized layer.

The volume of microspheres used to produce suitable levels of retroreflectivity is typically not under 50% of the dried coating or ink volume that remains on the surface of the substrate. However, the use of a porous substrate (such as paper or textile) permits development of practical reflectivity at microsphere volumes of less than 50%, because some of the carrier vehicle is absorbed into the substrate. For porous substrates, some reflectivity may occur at microsphere volumes as low as 5% of the total dry solids volume, depending upon the absorption of the carrier vehicle. With porous surfaces microsphere volumes as low as 14% by volume of total solids volume produce suitable retroreflectivity. A practical upper limit of microsphere volume is 70%, depending upon the particular wetting and bonding properties of the carrier vehicle solids.

Microspheres in accordance with the present invention have diameters from about 1 to about 100 micrometers, preferably from about 10 to about 80 micrometers. The dry film thickness of the coating or ink, on a non-porous substrate, is substantially the same as the diameter of the microspheres being used. For example, for microspheres with diameters of about 35 to 50 micrometers, the dry film thickness should be from 25 to 50 micrometers.

Retroreflective compositions for spraying, based on high density retroreflective glass microspheres, need to have modified rheological characteristics, because the glass has a specific gravity of 4 to 4.2 and tends to settle in most liquid vehicles in seconds. Thus, the compositions of the present invention have a viscosity which is low enough to permit a propellant to transport the liquid out of the container and vaporize the liquid so that it can be deposited on the substrate. However, the viscosity is not so low as to allow the liquid to run at the desired wet film thickness. Accordingly, the microspheres of the present invention do not separate during the drying process, nor do they settle hard in the container. The invention provides a method for accomplishing soft settling of about 50 to about 60% by weight of microspheres, when coatings are packaged in an aerosol container. The viscosity characteristics developed in accordance with the present invention are such that the low-shear viscosity is substantially above 5,000 cps and the high-shear viscosity is substantially under 1,500 cps at 25° C. (77° F.), when measured on a Brookfield or other suitable viscometer. In certain embodiments, retroreflective compositions of the present invention exhibit low shear viscosity of over 15,000 cps and high shear viscosity of under 500 cps.

This rheological control is accomplished by the addition of a synergistic thixotropic blend containing at least two thixotropic agents. Non-limiting examples include clay, modified clay, calcium sulphonate complex, silica-gel or organic gellant, including the acrylic acid types or modified cellulosic materials. A non-limiting example of a modified clay includes BENTONE LT or BENTONE 38 (trademark of Elementis Specialtie) for its organoclay mineral (smectite) product). A non-limiting example of a silica-gel includes HDKN20 (trademark of Wacker-Chemie), or AEROSIL (trademark of Degussa). The first thixotropic agent of the present invention partially prevents the hard settling of microspheres and controls penetration of binder into porous substrates.

Non-limiting examples include polyurea dispersions, polyurethane dispersions, or other products known in the art. The second thixotropic agent gives a high viscosity when not under shear, but a much lower viscosity when sheared. Further, the second thixotropic agent also contributes to anti-settling, but allows the liquid to be sprayed at high shear. Depending upon the recovery time of the thixotrope after shearing, this second thixotropic agent can also control the penetration into porous substrates. In accordance with an embodiment of the present embodiment, the thixotropic blend is present in amounts from about 2% to 5% by weight of the retroreflective composition. The ratio of the first thixotropic agent to the second thixotropic agent is about 2:1 to about 3:1. The percentage of thixotropic blend is significantly higher than that recommended or required with conventional retroreflective compositions.

Either water-thinned or solvent-thinned binder systems can be used to formulate practical sprayable coatings or inks, including aerosols. The binders may be organic or inorganic polymers. Any thermoplastic, or thermosetting polymer may be used, as long as the polymer may be dried or cured at ambient temperatures, or heated to crosslink the polymer. Non-limiting examples of the polymer binder include acrylic, styrene-acrylic, styrene-butadiene, polystyrene, polyester, chlorinated polyolefin, chlorinated rubber, cellulose esters, polyvinyl chloride, polyvinyl acetate-ethylene, and urethane polymers. A non-limiting example of inorganic polymers includes silicates and silicones. Other non-limiting examples include water-thinned, solvent thinned, thermoplastic and thermosetting systems (moisture-cured), conventional, chain stopped, monomer modified alkyd and polyester resins and, and epoxy polymers.

The polymer binders can be thinned to give the minimal practical level of solids volume that will permit adequate performance of the dry coating. Typically, this level is 10 to 30% solids, by volume. For non-porous substrates, non-volatile binder solids may be from 10 to 50% by volume of the dry coating or ink. For porous substrates, binder volume solids may be 100%. Many of the retroreflective compositions of the present invention are formulated at a high pigment volume content (i.e. formulated at “Over the Critical Pigment Volume Concentration”) and, therefore, are considered “binder-starved”. The proportion of microspheres to the polymer binder must be such that the resin layer thickness, after drying the coating, should be no more than 50% of the mean microsphere diameter. The majority of microspheres must protrude from the coating layer, into the air interface.

In accordance with an embodiment of the present invention, adhesion of the microspheres to the binder matrix, as well as adhesion of the retroreflective compositions to a substrate, can be adjusted through use of coupling agents (also referred to as bonding agents). Non-limiting examples of coupling agents include silanes, titanates, zirconates, aluminates, zircoaluminates and alkyl phosphate esters. The coupling agents are used at levels sufficient to apply a monolayer on the microspheres or substrate surface. To gain optimum adhesion, the coupling agent constitutes between approximately 0.05% and 2.0% of the microsphere weight, depending upon the surface area of the retroreflective microspheres.

In addition to the coupling agents, the metallized microspheres of the present invention can be treated with a protective, water-insoluble anti-corrosive material and an acid acceptor/scavenger. Water and some binder systems can attack the aluminized coating of the microspheres, which is typically only 50 to 500 Angstrom Units (Å) thick. In solvent-thinned systems that may have acidic compounds present, a corrosion inhibitor, and/or an acid acceptor/scavenger is chosen to protect the thin vacuum-metallized microsphere surface. In water-thinned systems, the metallized surface must be protected by one of the well known compounds capable of physically or chemically protecting the metal from electrolytic attack.

In accordance with other embodiments of the present invention, the microspheres are simultaneously treated with one or more coupling agents and a protective, water-insoluble anti-corrosive material and an acid scavenger (i.e. an emulsifiable epoxy compound). The stabilizers may be one or more of (a) a low HLB, water-insoluble surfactant; (b) a water and solvent soluble anti-corrosive additive based on a partially acid neutralized ozazolidine, or anti-corrosive pigment dispersions, or (c) a triazole complex. The term “HLB” refers to the Hydrophile-Lipophile Balance system, a standard measurement in the specialty chemicals industry.

The retroreflective compositions of the present invention may be formulated with one or more colorants. One or more distinct colorings can be formulated in one product, one color being a fluorescent coating and the other being a retro-reflective coating, using the retroreflective microspheres as a pigment. The fluorescent and retroreflective portions in the coating can be varied from 1% to 99% of either color. Methods for producing multicolored compositions are well known in the art and the Zolatone technique for making “multicolor” lacquers is just one suitable method for the present invention. Alternatively, pigment particles of various colors may be incorporated into the retroreflective compositions of the present invention. Transparent pigment particles yield improved retroreflectivity. Pigment particles are well known in the art and available in several grades and size ranges.

The relative amounts of the ingredients of the retroreflective composition of the present invention will, of course, vary depending upon the particular ingredients employed, the type of substrate, the substrates intended use, as well as such factors as the specific size and quantity of the retroreflective microspheres. The following Table 1 is a listing of ingredients employed in the preparation of the retroreflective compositions of the present invention, including both the typical and preferred amounts of each ingredient.

TABLE 1

| | |
|---|---|
| Amount (kg) | Preferred Amount (kg) |

| | | |
|---|---|---|
| Solvent | 300-600 | 375-490 |
| Solids Resin Granules | 35-65 | 45-55 |
| Thixotrope #1 | 15-35 | 20-30 |
| Thixotrope #2 | 3-15 | 7-13 |
| Acid Scavenger/Acceptor | 0-5 | 1-3 |
| Thixotrope Activator | 0-35 | 20-30 |
| Microspheres | 300-600 | 350-500 |
| (plus coupling agent) | (under 5) | (under 3) |
| Total | approx. 1,000 kg | approx. 1,000 kg |

The invention will be further described with the following non-limiting Example:

| Example 1 | Amount (kg) |
|---|---|
| Solvent (Aliphatic or Aromatic Naphtha) | 447 |
| 100% Solids Resin Granules (Acrylic) | 53 |
| Thixotrope #1 (Polyurea Type) | 26 |
| Thixotrope #2 (Calcium Sulphonate Complex | 11 |
| Acid Scavenger/Acceptor (Epoxidized Oil) | 2 |
| Thixotrope Activator (Isopropanol) | 26 |
| Microspheres | 435 |
| (plus coupling agent) | (under 1) |
| Total | approx. 1,000 kg |
| Viscosity-Brookfield #3 Spindle @ 25 ° C. | |
| 0.5 RPM 9,000 to 30,000 cps | |
| 20 RPM 600 to 1,900 cps | |
| Specific Gravity: 1.3 to 1.4 | |
| Solids % by Weight: 50 | |
| Vehicle Solids % by Weight: 11.4 | |
| Microspheres % of formulation: 43.5 | |

In accordance with one embodiment of the present invention, the retroreflective composition of Example 1 is prepared with the following methodology. An initial portion of a solvent such as an aliphatic or aromatic naphtha (i.e. 10-20% of the total solvent) is placed in a mixing tank. A variable high speed “sawtooth” disperser (Cowles Dissolver type) is an acceptable mixer. The solids resin granules (100% acrylic resin granules) are slowly added to the mixing tank, so that a thick, but liquid mass is produced. Other solvents used with the present invention include virtually any solvent that will dissolve the solid resin granules without dissolving the microspheres. Examples include aliphatic and aromatic solvents, ketones, esters, glycoethers, alcohols, halogentated hydrocarbons and water. The mixer speed is adjusted upwards, so that the liquid temperature rapidly rises to 30 to 45° C., usually within 10 minutes. The first and second thixotropes are then added and mixed until dispersed and activated. The balance of the solvent is then added, with stabilizer(s) and other necessary ingredients, such as thixotrope activators, including, but not limited to isopropanol.

The microspheres, whether pre-treated with coupling agent(s) or not, are added at moderate mixer speed, such as 1,000 to 2,000 feet per minute blade tip speed. After from 5 to 10 minutes the mixer is stopped and a sample is examined to determine that the viscosity and other characteristics, such as microsphere suspension, specific gravity and solids content are within specification.

Certain thixotropes do not activate and stabilize the viscosity for up to 24 hours. For formulations containing these thixotropes, the batch is held overnight, re-mixed and tested. Correctly formulated and mixed products do not separate or settle for a minimum of 24 hours and usually not for several weeks. Eventual settling is soft and easily re-mixed by light shaking. The invention provides a method for accomplishing soft settling of about 50 to about 60% by weight of microspheres, when coatings are packaged in an aerosol container. A packaged composition of the invention in aerosol form, has a storage shelf stability of at least two-years.

The aerosol filling is done on conventional filling equipment, known to the trade. The actuator valve is of a special type, that permits strong seating of the valve after spraying product. This ensures that the relatively large microspheres do not hold the valve partially open, which would allow propellant and resin to leak. Liquefied propellants and compressed gases normally used in aerosol applications are suitable. Non-limiting examples include propane and isobutane.

The present invention enjoys industrial applicability in the retroreflective coating of various substrates, not limited to the following: roadway signs, roadway markers, tree marking paint, and highway barriers or guardrails.

While the invention has been particularly shown and described with reference to particular embodiments thereof, it will be understood by those skilled in the art that the foregoing and other changes in form and details may be made therein without departing from the spirit and scope of the invention. The foregoing description has been presented only for the purposes of illustration and is not intended to limit the invention to the precise form disclosed.

What is claimed is:

1. A retroreflective composition comprising:
a plurality of retroreflective microspheres;
a binder system; and
a thixotropic blend comprising at least two thixotropic agents, said thixotropic blend being present in an amount from about three to about five percent by weight of said retroreflective composition.

2. The composition of claim 1, wherein the plurality of retroreflective microspheres are either plastic or glass and have a refractive index of about 1.8 or higher.

3. The composition of claim 2, wherein the plurality of retroreflective microspheres have a diameter from about 1 to about 100 micrometers and mixtures thereof.

4. The composition of claim 3, wherein the plurality of retroreflective microspheres have a diameter from about 10 to about 80 micrometers and mixtures thereof.

5. The composition of claim 2, wherein the plurality of retroreflective microspheres are optionally hemispherically metallized.

6. The composition of claim 5, wherein 0% to 100% of the retroreflective microspheres are hemispherically metallized with one or more reflective metals selected from aluminum, silver and gold.

7. The composition of claim 1, wherein the thixotropic blend contains a first and second thixotropic agent, and
said first thixotropic agent is selected from the group consisting of clays, modified clays, silica-gels, calcium sulphonate complexes, and organic gellants; and
said second thixotropic agent is selected from a polyurea or a polyurethane dispersion.

8. The composition of claim 1, wherein the binder system is water-thinned or solvent-thinned.

9. The composition of claim 8, wherein the binder system further comprises polymeric binders selected from the group consisting of acrylic, styrene-acrylic, styrene-butadiene, polystyrene, polyester, chlorinated polyolefin, chlorinated rubber, cellulose ester, polyvinyl chloride, polyvinyl acetate-ethylene, urethane and silicate polymers.

10. The composition of claim 1, further comprising one or more of the following ingredients selected from the group consisting of: coupling agent(s), acid scavenger(s), corrosion inhibitor(s), thixotrope activator(s), surfactant(s), colorant(s) and pigment(s).

11. The composition of claim 1, formulated in the form of an aerosol spray.

12. The composition of claim 11, wherein the aerosol spray has a low-shear viscosity greater than 5,000 cps and a high-shear viscosity less than 1,500 cps at 25° C.

13. The composition of claim 12, wherein the aerosol spray has a low-shear viscosity greater than over 15,000 cps and a high-shear viscosity less than 500 cps at 25° C.

14. An article comprising the composition of claim 1, said article selected from roadway signs, roadway markers, tree marking paint, highway barriers or guardrails.

15. A retroreflective composition comprising the following ingredients:
a solvent from about 30 to 60 percent by weight;
solids resin granules from about 3.5 to 6.5 percent by weight;
a first thixotropic agent from about 1.5 to 3.5 percent by weight;
a second thixotropic agent from about 0.3 to 1.5 percent by weight;
a plurality of microspheres from about 30 to 60 percent by weight;
an optional acid scavenger/acceptor from about 0 to 0.5 percent by weight;
an optional thixotrope activator from about 0 to 3.5 percent by weight; and
an optional coupling agent from about 0 to 5 percent by weight.

16. A method of making a retroreflective composition comprising the following sequential steps:
(a) dispersing a polymeric binder in a portion of a first solvent to form a liquid mass;
(b) dispersing and activating at least two thixotropes in said liquid mass;
(c) adding the balance of the first solvent; and
(d) adding a plurality of retroreflective microspheres, wherein the retroreflective composition comprises from about three to about five percent by weight of said at least two thixotropes.

17. The method of claim 16, wherein step (a) comprises:
(i) adding a portion of the first solvent in a mixing tank and then adding the polymeric binder to form a liquid mass;
(ii)increasing the mixer speed to obtain a temperature of the liquid mass from about 30 to 45° C.

18. The method of claim 16, wherein step (b) comprises:
(i) adding one or more stabilizer(s), color pigments, or thixotrope activator(s).

19. The method of claim 16, wherein step (d) comprises:
(i) pre-treating the retroreflective microspheres with one or more coupling agents.

20. The method of claim 16, further comprising:
(i) aerosol filling the retroreflective composition to form a retroreflective aerosol spray can
(ii) use of an actuator valve that permits the strong seating of the valve after spraying the retroreflective composition.
